(19) United States
(12) Patent Application Publication
(10) Pub. No.: US 2015/0339632 A1
(43) Pub. Date: Nov. 26, 2015

(54) SYSTEM AND METHOD FOR PROMOTION OF EVENTS

(71) Applicant: PARTY EDU, LLC, Circleville, OH (US)

(72) Inventor: Lucas A. Thompson, Circleville, OH (US)

(73) Assignee: PARTY EDU, LLC, Circleville, OH (US)

(21) Appl. No.: 14/718,511

(22) Filed: May 21, 2015

Related U.S. Application Data
(60) Provisional application No. 62/001,136, filed on May 21, 2014.

(51) Int. Cl. G06Q 10/10; G06Q 50/00; G01S 19/13

(52) U.S. Cl. CPC G06Q 10/1095; G01S 19/13; G06Q 50/01

(57) ABSTRACT

The disclosure provides a system for promoting events to one or more individuals.

### CROSS-REFERENCE TO RELATED APPLICATIONS

This application claims priority to Provisional Patent Application No. 62/001,136, filed May 21, 2014, which is hereby incorporated by reference in its entirety.

### FIELD OF THE INVENTION

This disclosure relates in general to a method and system for promotion of events.

### BACKGROUND

The disclosed subject matter provides a method and system comprising event peripherals. The method and system may organize and provide events for one or more individuals.

### BRIEF SUMMARY OF THE INVENTION

The present disclosure provides a system for promoting events to individuals. The system may comprise at least one processor, at least one memory coupled with the at least one processor for storing planned event information relating to a plurality of planned real-world events. The planned event information may comprise information identifying the plurality of planned real-world events.

An event registry module may be operably coupled with a first processor and a first memory and may be operable to provide the planned event information.

A second memory may be coupled with a second processor for storing personal identification information relating to a plurality of individual users. A user registry module may be operably coupled with the second processor and the second memory and may be operable to provide the personal identification information for the plurality of individual users.

A third memory may be coupled with a third processor for storing event notification information. An event notification module may be operably coupled with the third processor and the third memory and may receive at least a portion of the planned event information relating to the plurality of planned real-world events. The event notification module may be further operable to receive at least a portion of the personal identification information for the plurality of individual users. The event notification module may be further operable to determine, in relation to at least one authorization criteria, an authorizing relationship between the at least a portion of the planned event information for the plurality of planned real-world events and the at least a portion of the personal identification information for the plurality of individual users. In embodiments, the event notification module may be operable to provide the event notification information to each of the plurality of authorized users based on the authorizing relationship.

A fourth memory may be coupled with a fourth processor for storing event promotion information. The event promotion information may comprise information for promoting attendance for at least one of the planned real-world events. An event promotion module may be operably coupled with the fourth processor and the fourth memory and may be operable to receive at least a portion of the planned event information. In embodiments, the event promotion module may be operable to receive event promotion information relating to at least a portion of the planned event information for at least one of the plurality of planned real-world events. In embodiments, the event promotion module may be operable to distribute to the authorized users the event promotion information relating to the at least one promoted real-world event.

A fifth memory may be coupled with a fifth processor for storing event monitoring information. The event monitoring information may comprise information for monitoring at least one of the plurality of individual users. An event monitoring module may be operably coupled with the processor and the memory and may be operable to receive at least a portion of the personal identification information for each of the plurality of individual users in attendance at an occurrence of at least one of the plurality of planned real-world events. In embodiments, the event promotion module may be operable to provide event monitoring information in relation to attendance at the occurrence of the at least one of the plurality of planned real-world events.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of the appended claims and/or those claims filed later.

### BRIEF DESCRIPTIONS OF THE DRAWINGS

The novel features believed characteristic of the presently disclosed subject matter are set forth in the claims appended hereto or will be set forth in any claims that are filed herewith or later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays a computing system and related peripherals that may operate with the system and method for providing event promotion information in accordance with embodiments.

FIG. 2 depicts a generalized flow diagram of a system in accordance with embodiments.

FIG. 3 depicts a generalized flow chart of a method in accordance with embodiments.

FIG. 4 depicts a screenshot of an electronic device based computer application employing the enclosed method and system and showing peripherals of an event including location, contact, and cost information.

FIG. 5 depicts a screenshot of an electronic device based computer application employing the enclosed method and system and showing peripherals of an event including a guest list.

### DETAILED DESCRIPTION OF THE SPECIFIC EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

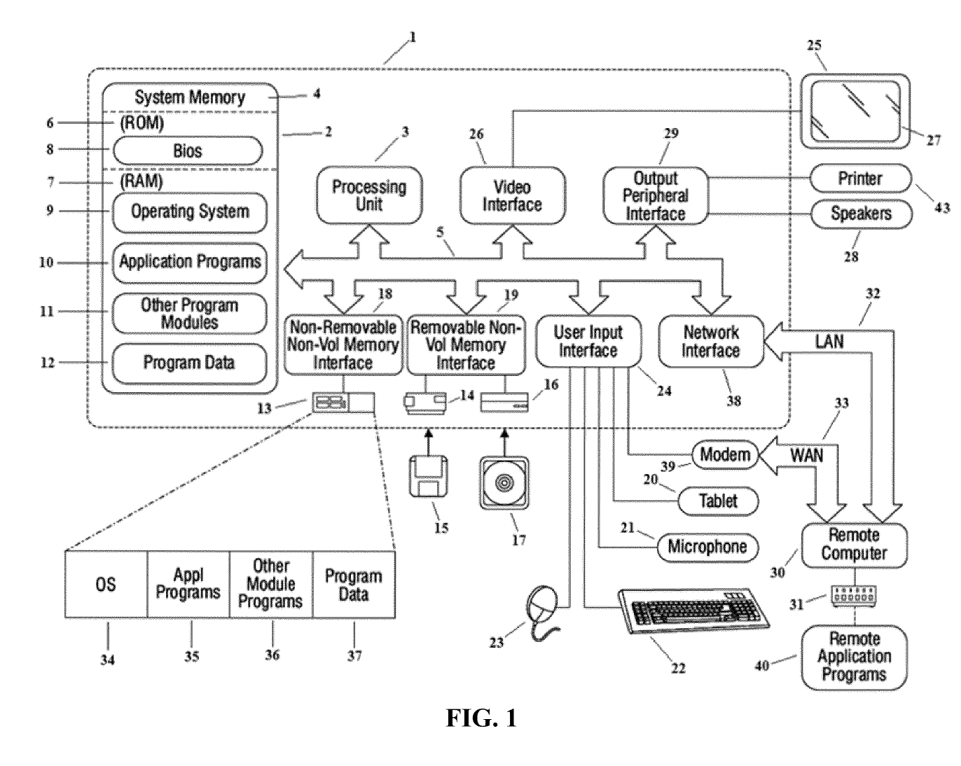

With reference to FIG. 1, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system 8 (BIOS), containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11 and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36 and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

For the purposes of this disclosure, it is appreciated that the terms “device”, “processor based mobile device”, “mobile device”, “electronic device”, “processor based mobile electronic device”, “mobile electronic device”, “location-capable wireless device”, and “individual's electronic device” may be synonymous with remote computing system 30 and/or electronic device 205.

The central processor operating pursuant to operating system software such as, but not limited to IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

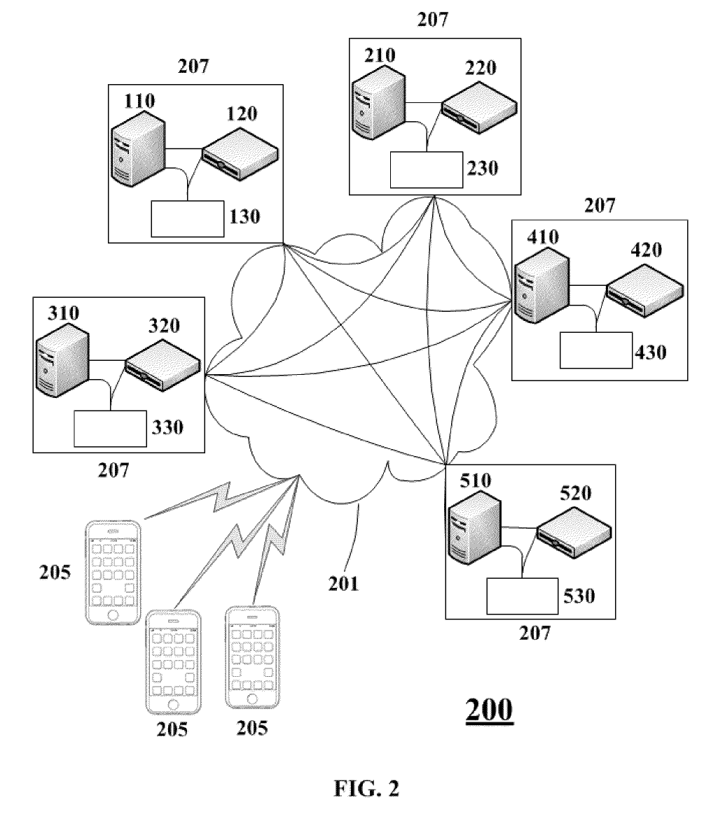

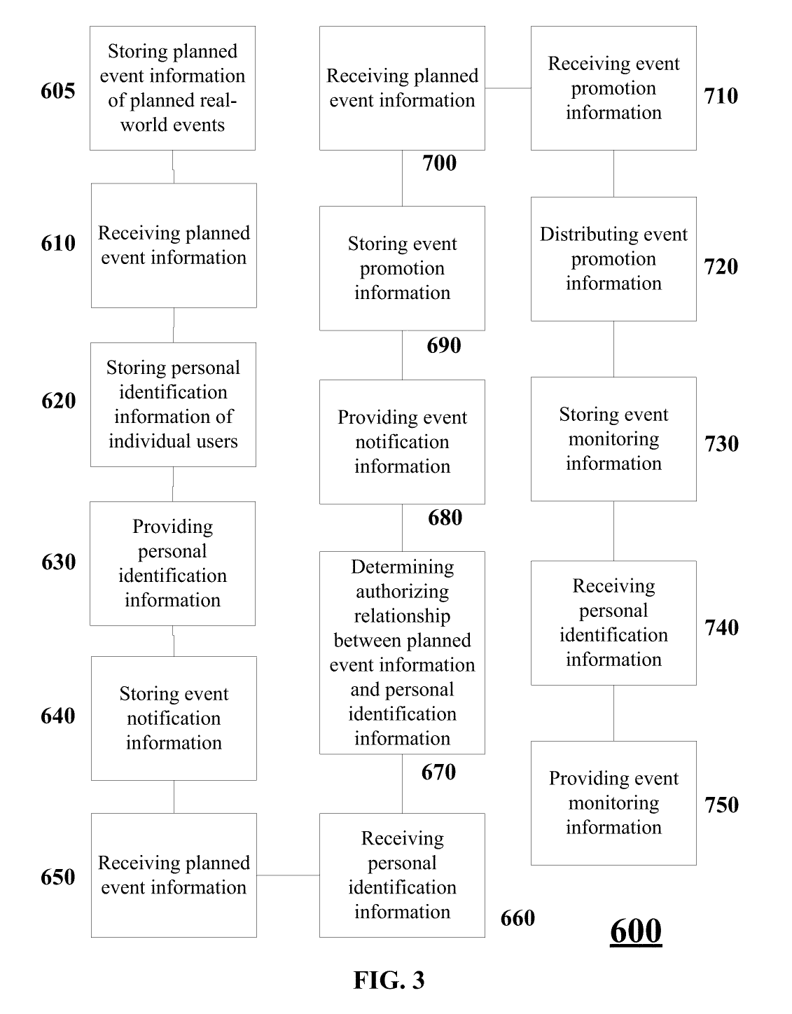

FIG. 2 depicts a generalized flow diagram of a system 200 in accordance with embodiments. In embodiments, system 200 may include a computing system 207 having at least one processor and at least one memory accessible for storing and accessing information or data. It will be understood that in embodiments system 200 may include a computing system 207 such as or further including, for example, computing system 1. In embodiments, system 200 may include a data transmission or communications network such as, for example, an Internet Protocol network, configured and operable for transmitting or conveying communications between computing system and a plurality of wireless handheld computing devices such as, for example, smartphones, tablet computing devices, smart devices such as wireless enabled smartwatches, or notebook computers. In embodiments, the system 200 may perform of carry out all or a portion of steps of a method for promoting events, such as method 600 illustrated in FIG. 3. Returning to FIG. 2, in the particular embodiment illustrated therein, system 200 is includes five sets of component groups 207. It will be understood that in other embodiments, a system 200 for promoting events may include a different number of component groups 207 such as, for example, more than five sets of component groups 207. Each component group 207 may include, for example, at least one processor, at least one memory, and at least one module. Each of the sets is connected to one another via links and/or at least one network 201 so that information in any part of the system may be transmitted to any other part of the system. In embodiments, the at least one network 201 may be a network as described in the description of FIG. 1. Any information transmitted between component groups 207 via links and/or at least one network 201 may be transmitted, via the network, to at least one electronic device 205. In embodiments, the information may be sent directly to a computing application found on the electronic device 205. In embodiments, electronic device 205 may share one or more elements of remote computing system 30. In embodiments, one or more modules of the system 200 may be partially embodied in software and/or hardware. In embodiments, one or more modules of the system 200 may be wholly embodied in software or hardware.

For the purposes of this disclosure, the terms “computing system 207” and “component group 207” may be synonymous. For the purposes of this disclosure, the terms “electronic device 205” and “remote computing system 30” may be synonymous. In embodiments, method 600 and/or system 200 may be embodied in remote computing system 30.

System 200 may store planned event information relating to a plurality of planned real-world events. In embodiments, the planned event information may comprise information identifying the plurality of planned real-world events. The planned event information may be stored in at least one memory via at least one processor. In embodiments, the planned event information may be stored in a central computing system (such as, but not limited to, computing system 1) including at least one memory and at least one processor. The planned event information may be entered into a graphical user interface of an electronic device of an individual that creates a planned event. The planned event information may be sent to the central computing system via a network such as, but not limited to, a WAN 33. In embodiments, planned event information may include, but is not limited to the location of a planned event, the time period of a planned event, the duration of a planned event, and the theme of a planned event. In embodiments, planned event information may include a guest list that may include the contact and or biographical information of one or more individuals.

System 200 may provide planned event information. The information may be provided via an event registry module 130, which may be operably coupled with a first processor 110 and a first memory 120. Planned event information may be retrieved from the central computing system via a link and may be sent as computer readable code to the event registry module 130. Via one or more links, the information may be processed by the first processor 110 and stored in the first memory 120. The information may be provided as public information on an application on an electronic device. For example, information may be provided (and accessible) concerning a “public” event through an application on electronic device 205. So any individual that has access to the application may be provided information concerning this event.

System 200 may store personal identification information relating to a plurality of individual users. The information received by a second processor 210 may be processed and subsequently stored in a second memory 220. The information received may be information input by an individual that may constitute account information for an application on an individual's electronic device 205. In embodiments, the personal identification information may be information entered when an individual creates and enters event information into the application.

System 200 may provide personal identification information for the plurality of individual users. The personal identification information may be provided via a user registry module 230. In embodiments, this information may be provided via a network to users of an application on electronic device 205. The information may be provided in response to actions such as, but not limited to a user search within the application and a user query when viewing event goers for an event found on the application (such as engaging a linked name on a guest list). The user search may be carried out by either another user generally searching for a user via a keyword search or a user creating an event searching for users to invite to an event via event creation screens on electronic device 205.

System 200 may store event notification information. A user creating an event may send event notification information (such as by electronic device 205) to a third processor 310 that may process the information. The information may then be sent via a link from the third processor 310 to a third memory 320 and subsequently stored. The event notification information may include information such as, but not limited to information concerning parameters of an event for one or more users invited to the event. System 200 may receive at least a portion of the planned event information relating to the plurality of planned real-world events. The information may be received by an event notification module 330, which may be operably coupled to the third processor 310 and the third memory 320. The planned event information may be received via network 201 from at least one electronic device (such as at least one of electronic device 205) of at least one user that may be authorized to input planned event information for a certain planned event. The event notification module 330 may further receive at least a portion of the personal identification information for the plurality of individual users. This information may be received from an application on one or more electronic devices 205 that may have been input when a user had signed up for a specific service that the application provided. The information may be sent to the event notification module 330 via a network from one or more user electronic devices 205.

In embodiments, the information may be received via an individual who is creating a planned event in an application on their electronic device 205. The individual may be allowed to input into their electronic device 205 at least names of registered users of the application and/or be allowed to select registered users that the individual would like to invite to an event. Once names are selected by the individual, the information, such as, but not limited to names, may be sent to the event notification module 330 via a network. Once the event notification module 330 receives the information, the event notification module 330 may further be capable of accessing additional personal identification information correlating with the information received via a link to the second memory 220 and/or via the network 201.

The event notification module 330 may determine, in relation to at least one authorization criteria, an authorizing relationship between the at least a portion of the planned event information for the plurality of planned real-world events and the at least a portion of the personal identification information for the plurality of individual users. The determining may relate to a situation where a user is pre-qualified to attend an event based on a parameter entered into the application by the user. This step may not be necessary when a user creates a private planned event, wherein all of the authorized users are decided by the user who created the private planned event and are the only users attending. The event notification module 330 may receive a query that a user of an application may be searching for events to attend. The query may include a portion of personal identification information that may be compared and/or matched with planned event information retrieved by the event notification module 330 from the at least one memory.

The event notification module 330 may then provide the event notification information to each of the plurality of authorized users based on the authorizing relationship. It is noted that the authorized users may be users that are authorized to attend an event based on the determining by the event notification module 330.

In embodiments, the planned event information may be sent to one or more electronic devices 205 automatically based upon the authorizing relationship confirmation. In this embodiment, planned event information in the form of computer readable code may be input into a computing system 200 and/or an electronic device 205 and may be subsequently distributed to the one or more individual's electronic devices 205 via a network 201. The information received by the one or more individual's electronic devices 205 may be in the form of computer readable code that may be processed to show details of an event in a form such as, but not limited to, an interactive map, written text, and graphics. In embodiments, an individual may access information to planned event information via a keyword search within an application on an electronic device 205. In embodiments, an application in an electronic device 205 may allow an individual to “invite” another individual. Access to the information may be authorized and sent from one individual to another individual via an electronic message (through a network, such as network 201). The electronic message may include authorization for the individual being sent the electronic message. The computing system 200 may include an email and/or message server that may act as a medium in which the electronic message may pass and be sent to the receiving individual electronic device 205.

System 200 may store event promotion information. The event promotion information may be a subgroup of information from the planned event information that may be labeled as event promotion information by the at least one processor when a user creates an event and classifies it as a “public” event or a “partially public” event. For the purposes of this disclosure, a public event may be an event that is open to at least a majority of users having credentials for the disclosed application. For the purposes of this disclosure, a partially public event may be an event that is open to invited or “authorized” users as well as a majority of users having credentials for the disclosed application. When a user has created a planned event, the user may acknowledge during the input of planned event information into the application that the planned event may be a public event, a partially public event, or a private event. The storing of event promotion information may not apply when a user denotes an event as a private event. Planned event information, once input into the application, may be denoted as a specific type of information based on the status of the event and may be stored as such in the at least one memory. For example, information pertaining to a public event or a partially public event may be denoted as event promotion information. A fourth processor 410 may retrieve this information denoted as the event promotion information from the at least one memory via a link. Via a second link from the fourth processor 410 to a fourth memory 420, the event promotion information may be stored in the fourth memory 420. It is noted that the event promotion information may comprise information for promoting attendance for at least one of the planned real-world events, and specifically for public events and/or partially public events.

System 200 may receive at least a portion of the planned event information, receive event promotion information relating to at least a portion of the planned event information for at least one of the plurality of planned real-world events, and distribute to the authorized users the event promotion information relating to the at least one promoted real-world event; these steps may all be carried out by the event promotion module 430. The event promotion module 430 may receive the event promotion information from the fourth memory 420 via a link. The event promotion module 430 may receive the planned event information from the at least one memory via a link. The event promotion module 430 may distribute to each authorized user of an event the event promotion information to the application on each of the authorized user's electronic devices 205 via network 201.

System 200 may store event monitoring information. Users of the application attending a planned event may automatically have sent, by the users' electronic devices 205, information pertaining to planned event attendance (such as, but not limited to location and time of attendance) to a fifth processor 510 that may process the information. The event monitoring information may comprise information for monitoring at least one of a plurality of users of an application that are attending events. The information may then be sent via a link form the fifth processor 510 to a fifth memory 520 and subsequently stored. The information may include a timeframe at which a user was at the vicinity of an event. In embodiments, one or more users attending a specific event may have access to event monitoring information. In embodiments, the user who created the event may have access to event monitoring information.

System 200 may receive at least a portion of the personal identification information for each of the plurality of individual users in attendance at an occurrence of at least one of the plurality of planned real-world events. The information may be received by an event monitoring module 530, which may be operably coupled to the fifth processor 510 and the fifth memory 520. The personal identification information for each of the plurality of individual users in attendance at events may be received via network 201 from at least one electronic device 205 of at least one user attending a planned event. The system may provide event monitoring information in relation to attendance at the occurrence of the at least one of the plurality of planned real-world events. In embodiments, the event monitoring module 530 may provide the event monitoring information to electronic devices 205 of creators of a planned event through the application. In embodiments, the event monitoring module 530 may provide the event monitoring information to electronic devices 205 of users of the application. In embodiments, the information provided to the creators of a planned event may use the event monitoring information to figure out who is at their event and during what duration of time. In embodiments, the information provided to the users of the application may use the event monitoring information to view the users that are at certain events and during what duration of time.

In embodiments, the system may complete more tasks than those disclosed above. In embodiments, system 200 may complete fewer tasks than those disclosed above. The above description of a system is not limited to the configuration displayed; tasks completed may occur in a different order than that described above. In embodiments, system 200 may comprise more or less than the above mentioned components in order to complete the tasks mentioned above.

In embodiments, system 200 may include at least one processor, at least one memory, an event registry module 130, a user registry module 230, an event notification module 330, an event promotion module 430, and an event monitoring module 530.

FIG. 3 depicts a generalized flow chart of method 600 in accordance with embodiments. In embodiments, the method may be computer-implemented. Step 605 may involve storing planned event information relating to a plurality of planned real-world events. In embodiments, the planned event information may comprise information identifying the plurality of planned real-world events. The planned event information may be stored in at least one memory via at least one processor. In embodiments, the planned event information may be stored in computing system 200 that may include at least one memory and at least one processor. The planned event information may be entered into a graphical user interface of an electronic device 205 of an individual that creates a planned event. The planned event information may be sent to the computing system 200 via a network such as, but not limited to, a WAN 33. In embodiments, planned event information may include, but is not limited to the location of a planned event, the time period of a planned event, the duration of a planned event, and the theme of a planned event. In embodiments, planned event information may include a guest list that may include the contact and or biographical information of one or more individuals.

The planned event information may be provided in step 610. The information may be provided via an event registry module 130, which may be operably coupled with a first processor 110 and a first memory 120. Planned event information may be retrieved from computing system 200 via a link and may be sent as computer readable code to the event registry module 130. Via one or more links, the information may be processed by the first processor 110 and stored in the first memory 120. The information may be provided as public information on an application on one or more electronic devices 205. For example, information may be provided (and accessible) concerning a “public” event through an application on an electronic device 205. So any individual that has access to the application may be provided information concerning this event.

Personal identification information relating to a plurality of individual users may be stored in step 620. The information received by a second processor 210 may be processed and subsequently stored in a second memory 220. The information received may be information input by an individual that may constitute account information for an application on an individual's electronic device 205. In embodiments, the personal identification information may be information entered when an individual creates and enters event information into the application.

The personal identification information for the plurality of individual users may be provided in step 630. The personal identification information may be provided via a user registry module 230. In embodiments, this information may be provided via network 201 to users of an application on an electronic device 205. The information may be provided in response to actions such as, but not limited to a user search within the application and a user query when viewing event goers for an event found on the application (such as engaging a linked name on a guest list). The user search may be carried out by either another user generally searching for a user via a keyword search or a user creating an event searching for users to invite to an event via event creation screens on the electronic device 205.

Step 640 may involve storing event notification information. A user creating an event may send event notification information to a third processor 310 that may process the information. The information may then be sent via a link from the third processor 310 to a third memory 320 and subsequently stored. The event notification information may include information such as, but not limited to information concerning parameters of an event for one or more users invited to the event. Step 650 may involve receiving at least a portion of the planned event information relating to the plurality of planned real-world events. The information may be received by an event notification module 330, which may be operably coupled to the third processor 310 and the third memory 320. The planned event information may be received via a network from at least one electronic device 205 of at least one user that may be authorized to input planned event information for a certain planned event. The event notification module 330 may further receive, in step 660, at least a portion of the personal identification information for the plurality of individual users. This information may be received from an application on one or more user electronic devices 205 that may have been input when a user had signed up for a specific service that the application provided. The information may be sent to the event notification module 330 via a network from one or more user electronic devices 205.

In embodiments, the information may be received via an individual who is creating a planned event in an application on their electronic device 205. The individual may be allowed to input into their electronic device 205 at least names of registered users of the application and/or be allowed to select registered users that the individual would like to invite to an event. Once names are selected by the individual, the information, such as, but not limited to names, may be sent to the event notification module 330 via network 201. Once the event notification module 330 receives the information, the event notification module 330 may further be capable of accessing additional personal identification information correlating with the information received via a link to the second memory 220.

In step 670, the event notification module 330 may determine, in relation to at least one authorization criteria, an authorizing relationship between the at least a portion of the planned event information for the plurality of planned real-world events and the at least a portion of the personal identification information for the plurality of individual users. Step 670 may relate to a situation where a user is pre-qualified to attend an event based on a parameter entered into the application by the user. This step may not be necessary when a user creates a private planned event, wherein all of the authorized users are decided by the user who created the private planned event and are the only users attending. The event notification module 330 may receive a query that a user of an application may be searching for events to attend. The query may include a portion of personal identification information that may be compared and/or matched with planned event information retrieved by the event notification module 330 from the at least one memory.

The event notification module 330 may then provide the event notification information to each of the plurality of authorized users based on the authorizing relationship in step 680. It is noted that the authorized users may be users that are authorized to attend an event based on the determining step 670 by the event notification module 330.

In embodiments, the planned event information may be sent to one or more individual's electronic devices 205 automatically based upon the authorizing relationship confirmation. In this embodiment, planned event information in the form of computer readable code may be input into computing system 200 and subsequently distributed to the one or more individual's electronic devices 205 via network 201. The information received by the one or more individual's electronic devices 205 may be in the form of computer readable code that may be processed to show details of an event in a form such as, but not limited to, an interactive map, written text, and graphics. In embodiments, an individual may access information to planned event information via a keyword search within an application on an electronic device 205. In embodiments, an application in an electronic device 205 may allow an individual to “invite” another individual. Access to the information may be authorized and sent from one individual to another individual via an electronic message. The electronic message may include authorization for the individual being sent the electronic message. The computing system 200 may include an email and/or message server that may act as a medium in which the electronic message may pass and be sent to the receiving individual electronic device 205.

Step 690 may involve storing event promotion information. The event promotion information may be a subgroup of information from the planned event information that may be labeled as event promotion information by the at least one processor when a user creates an event and classifies it as a “public” event or a “partially public” event. For the purposes of this disclosure, a public event may be an event that is open to at least a majority of users having credentials for the disclosed application. For the purposes of this disclosure, a partially public event may be an event that is open to invited or “authorized” users as well as a majority of users having credentials for the disclosed application. When a user has created a planned event, the user may acknowledge during the input of planned event information into the application that the planned event may be a public event, a partially public event, or a private event. Step 690 may not apply when a user denotes an event as a private event. Planned event information, once input into the application, may be denoted as a specific type of information based on the status of the event and may be stored as such in the at least one memory. For example, information pertaining to a public event or a partially public event may be denoted as event promotion information. A fourth processor 410 may retrieve this information denoted as the event promotion information from the at least one memory via a link. Via a second link from the fourth processor 410 to a fourth memory 420, the event promotion information may be stored in the fourth memory 420. It is noted that the event promotion information may comprise information for promoting attendance for at least one of the planned real-world events, and specifically for public events and/or partially public events.

Steps 700, 710, and 720 involve receiving at least a portion of the planned event information, receiving event promotion information relating to at least a portion of the planned event information for at least one of the plurality of planned real-world events, and distributing to the authorized users the event promotion information relating to the at least one promoted real-world event, these steps all carried out by the event promotion module 430. The event promotion module 430 may receive the event promotion information from the fourth memory 420 via a link. The event promotion module 430 may receive the planned event information from the at least one memory via a link. The event promotion module 430 may distribute to each authorized user of an event the event promotion information to the application on each of the authorized user's electronic devices 205 via network 201.

Step 730 may involve storing event monitoring information. Users of the application attending a planned event may automatically have sent, by the users' electronic devices 205, information pertaining to planned event attendance (such as, but not limited to location and time of attendance) to a fifth processor 510 that may process the information. The event monitoring information may comprise information for monitoring at least one of a plurality of users of an application that are attending events. The information may then be sent via a link form the fifth processor 510 to a fifth memory 520 and subsequently stored.

Step 740 may involve receiving at least a portion of the personal identification information for each of the plurality of individual users in attendance at an occurrence of at least one of the plurality of planned real-world events. The information may be received by an event monitoring module 530, which may be operably coupled to the fifth processor 510 and the fifth memory 520. The personal identification information for each of the plurality of individual users in attendance at events may be received via network 201 from at least one electronic device 205 of at least one user attending a planned event. Step 750 may involve providing event monitoring information in relation to attendance at the occurrence of the at least one of the plurality of planned real-world events. In embodiments, the event monitoring module 530 may provide the event monitoring information to electronic devices 205 of creators of a planned event through the application. In embodiments, the event monitoring module 530 may provide the event monitoring information to electronic devices 205 of users of the application. In embodiments, the information provided to the creators of a planned event may use the event monitoring information to figure out who is at their event and during what duration of time. In embodiments, the information provided to the users of the application may use the event monitoring information to view the users that are at certain events and during what duration of time.

In embodiments, method 600 may comprise more steps than those disclosed above. In embodiments, method 600 may comprise fewer steps than those disclosed above. The above description of method 600 is not limited to the configuration displayed; steps in other embodiments of method 600 may occur in a different order than that described above.

In embodiments, the system (such as system 200) that may carry out above mentioned method 600 may include at least one processor, at least one memory, an event registry module 130, a user registry module 230, an event notification module 330, an event promotion module 430, and an event monitoring module 530.

The present disclosure may further provide an apparatus comprising at least one non-transitory data storage device that may have one or more computer programs stored thereon. The apparatus may be operable on one or more computing systems to carry out one or more tasks. The tasks may be similar to one or more steps of method 600 found in FIG. 3.

The apparatus may store planned event information relating to a plurality of planned real-world events. In embodiments, the planned event information may comprise information identifying the plurality of planned real-world events. The planned event information may be entered into a graphical user interface of an electronic device 205 of an individual that creates a planned event. The planned event information may be sent to the central computing system via a network such as, but not limited to, a WAN 33. In embodiments, planned event information may include, but is not limited to the location of a planned event, the time period of a planned event, the duration of a planned event, and the theme of a planned event. In embodiments, planned event information may include a guest list that may include the contact and or biographical information of one or more individuals.

The apparatus may provide planned event information. Planned event information may be retrieved from computing system 200 via a link and may be sent as computer readable code to the apparatus. The information may be provided as public information on an application on an electronic device 205. For example, information may be provided (and accessible) concerning a “public” event through an application on an electronic device 205. So any individual that has access to the application may be provided information concerning this event.

The apparatus may store personal identification information relating to a plurality of individual users. The information received may be processed and subsequently stored. The information received may be information input by an individual that may constitute account information for an application on an individual's electronic device 205. In embodiments, the personal identification information may be information entered when an individual creates and enters event information into the application.

The apparatus may provide personal identification information for the plurality of individual users. In embodiments, this information may be provided via network 200 to users of an application on an electronic device 205. The information may be provided in response to actions such as, but not limited to a user search within the application and a user query when viewing event goers for an event found on the application (such as engaging a linked name on a guest list). The user search may be carried out by either another user generally searching for a user via a keyword search or a user creating an event searching for users to invite to an event via event creation screens on the electronic device 205.

The apparatus may store event notification information. A user creating an event may send event notification information to the apparatus that may process the information and subsequently store the information. The event notification information may include information such as, but not limited to information concerning parameters of an event for one or more users invited to the event. The apparatus may receive at least a portion of the planned event information relating to the plurality of planned real-world events. The planned event information may be received via network 201 from at least one electronic device 205 of at least one user that may be authorized to input planned event information for a certain planned event. The apparatus may further receive at least a portion of the personal identification information for the plurality of individual users. This information may be received from an application on one or more user electronic devices 205 that may have been input when a user had signed up for a specific service that the application provided. The information may be sent to the apparatus via network 201 from one or more user electronic devices 205.

In embodiments, the information may be received via an individual who is creating a planned event in an application on their electronic device 205. The individual may be allowed to input into their electronic device 205 at least names of registered users of the application and/or be allowed to select registered users that the individual would like to invite to an event. Once names are selected by the individual, the information, such as, but not limited to names, may be sent to the apparatus via network 201. Once the apparatus receives the information, the apparatus may further be capable of accessing additional personal identification information correlating with the information received.

The apparatus may determine, in relation to at least one authorization criteria, an authorizing relationship between the at least a portion of the planned event information for the plurality of planned real-world events and the at least a portion of the personal identification information for the plurality of individual users. The determining may relate to a situation where a user is pre-qualified to attend an event based on a parameter entered into the application by the user. This step may not be necessary when a user creates a private planned event, wherein all of the authorized users are decided by the user who created the private planned event and are the only users attending. The apparatus may receive a query that a user of an application may be searching for events to attend. The query may include a portion of personal identification information that may be compared and/or matched with planned event information retrieved by the apparatus from the at least one memory.

The apparatus may provide the event notification information to each of the plurality of authorized users based on the authorizing relationship. It is noted that the authorized users may be users that are authorized to attend an event based on the determining by the apparatus.

In embodiments, the planned event information may be sent to one or more individual's electronic devices 205 automatically based upon the authorizing relationship confirmation. In this embodiment, planned event information in the form of computer readable code may be input into computing system 200 and may be subsequently distributed to the one or more individual's electronic devices 205 via network 201. The information received by the one or more individual's electronic devices 205 may be in the form of computer readable code that may be processed to show details of an event in a form such as, but not limited to, an interactive map, written text, and graphics. In embodiments, an individual may access information to planned event information via a keyword search within an application on an electronic device 205. In embodiments, an application in an electronic device 205 may allow an individual to “invite” another individual. Access to the information may be authorized and sent from one individual to another individual via an electronic message. The electronic message may include authorization for the individual being sent the electronic message. The central computing system may include an email and/or message server that may act as a medium in which the electronic message may pass and be sent to the receiving individual electronic device 205.

The apparatus may store event promotion information. The event promotion information may be a subgroup of information from the planned event information that may be labeled as event promotion information by the at least one processor when a user creates an event and classifies it as a “public” event or a “partially public” event. For the purposes of this disclosure, a public event may be an event that is open to at least a majority of users having credentials for the disclosed application. For the purposes of this disclosure, a partially public event may be an event that is open to invited or “authorized” users as well as a majority of users having credentials for the disclosed application. When a user has created a planned event, the user may acknowledge during the input of planned event information into the application that the planned event may be a public event, a partially public event, or a private event. The storing of event promotion information may not apply when a user denotes an event as a private event. Planned event information, once input into the application, may be denoted as a specific type of information based on the status of the event and may be stored as such in the at least one memory. For example, information pertaining to a public event or a partially public event may be denoted as event promotion information. It is noted that the event promotion information may comprise information for promoting attendance for at least one of the planned real-world events, and specifically for public events and/or partially public events.

The apparatus may receive at least a portion of the planned event information, receive event promotion information relating to at least a portion of the planned event information for at least one of the plurality of planned real-world events, and distribute to the authorized users the event promotion information relating to the at least one promoted real-world event. The apparatus may distribute to each authorized user of an event the event promotion information to the application on each of the authorized user's electronic devices 205 via network 201.

The apparatus may store event monitoring information. Users of the application attending a planned event may automatically have sent, by the users' electronic devices 205, information pertaining to planned event attendance (such as, but not limited to location and time of attendance) to the apparatus. The event monitoring information may comprise information for monitoring at least one of a plurality of users of an application that are attending events.

The apparatus may receive at least a portion of the personal identification information for each of the plurality of individual users in attendance at an occurrence of at least one of the plurality of planned real-world events. The information may be received by the apparatus. The personal identification information for each of the plurality of individual users in attendance at events may be received via network 201 from at least one electronic device 205 of at least one user attending a planned event. The apparatus may provide event monitoring information in relation to attendance at the occurrence of the at least one of the plurality of planned real-world events. In embodiments, the apparatus may provide the event monitoring information to electronic devices 205 of creators of a planned event through the application. In embodiments, the apparatus may provide the event monitoring information to electronic devices 205 of users of the application. In embodiments, the information provided to the creators of a planned event may use the event monitoring information to figure out who is at their event and during what duration of time. In embodiments, the information provided to the users of the application may use the event monitoring information to view the users that are at certain events and during what duration of time.

In embodiments, the apparatus may perform more tasks than those disclosed above. In embodiments, the apparatus may perform fewer tasks than those disclosed above. The above description of an apparatus is not limited to the configuration displayed; tasks performed by other embodiments of the apparatus may occur in a different order than that described above.

In embodiments, system 200 that may utilize the above mentioned apparatus may include at least one processor, at least one memory, an event registry module 130, a user registry module 230, an event notification module 330, an event promotion module 430, and an event monitoring module 530.

In embodiments, information available to a user of the application for a public event may include, but is not limited to the time of the party, the location of the party, the college affiliation of the party, the cost of entry for the party, the title of the party, a picture of the party (as an update during the party), other details of the party, and the theme of the party.

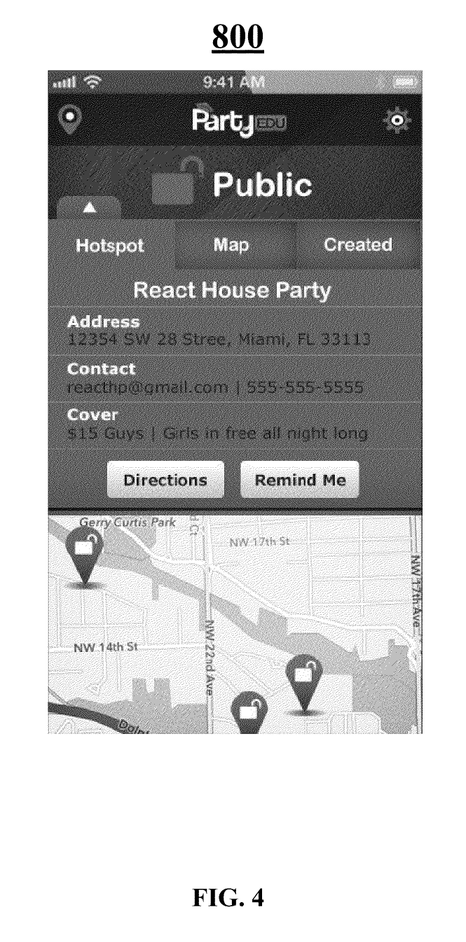

FIG. 4 depicts a screenshot 800 of an electronic device based computer application employing the enclosed method 600 and system 200 and showing peripherals of an event including location, contact, and cost information. The screen shown may be implemented on a graphical user interface of an electronic device 205. This may allow for a user to physically interact with the screen. The screen depicted shows an example of a public event (in this case, a house party named “React House Party”). Information for public events that are popular may be viewed under the “Hotspot” tab (currently engaged in the screenshot). Specific information for an event may be shown when a user engages a pin or marker on the interactive map shown at the bottom of the screen. The information shown for the party may include, but is not limited to an address for the event, contact information for the event, and cover (cost) information for the event. Furthermore, a user may engage the “directions” icon and be led to a screen that may display detailed directions to the event. The user may engage the “remind me” icon in order to be led to a screen where the user may set up a reminder message that may be shown on the user electronic device 205 at the time that the user sets the reminder to show on their electronic device 205. When a user engages the “Map” tab, a screen showing an enlarged version of the map found at the bottom of the screenshot may be shown on the electronic device 205. In embodiments, the enlarged version of the map may show events other than popular parties (as well as popular parties). When a user engages the “created” tab, the user may be led to a screen that may display information pertaining to an event that the user had created. In embodiments, there may be more than three tabs that the user may engage.

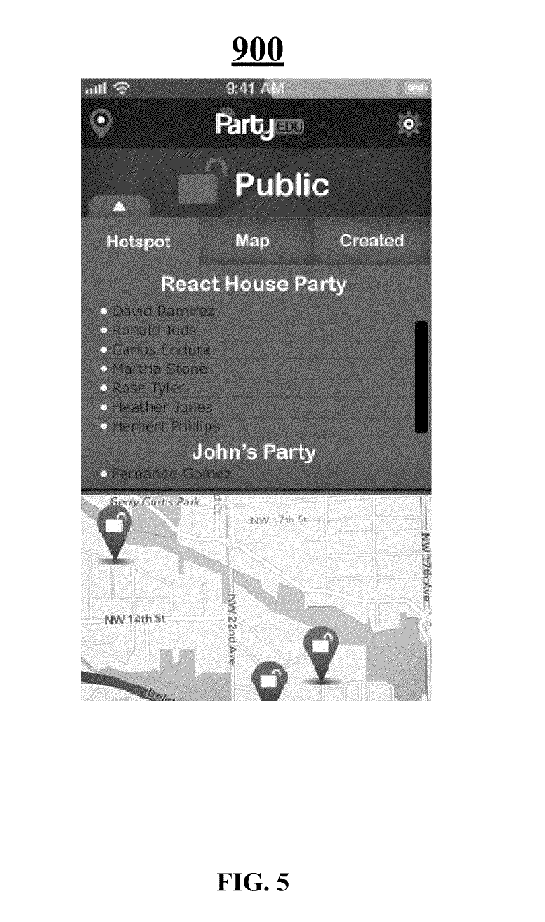

FIG. 5 depicts a screenshot 900 of an electronic device based computer application employing the enclosed method 600 and system 200 and showing peripherals of an event including a guest list. The user may view a guest list of the shown event by scrolling down the screen in FIG. 4. The current screen may show one or more guest lists for one or more events. The screen of FIG. 5 may share similar interactive tabs and icons as the screen found in FIG. 4. In embodiments, there may be more than three tabs that the user may engage.

In embodiments, events that may be created on the electronic device based computer application may include public parties, private parties, greek parties, featured events, and bar events. In embodiments, private party information may be located in a private invitation folder within the computer application that may only be accessible by eligible users of the application. In embodiments, greek parties may be denoted on a map as a greek symbol icon. In embodiments, private parties may be denoted on a map as a house icon. In embodiments, featured events may be denoted on a map as a star. In embodiments, bar events may be denoted on a map as a beer mug icon. In embodiments, a party may be classified as silver if there are more than 50 confirmed users that may attend the party. In embodiments, a party may be classified as gold if there are more than 100 confirmed users that may attend the party. In embodiments, the icons depicting a “silver” event may be silver. In embodiments, the icons depicting a “gold” event may be gold. In embodiments, a user may filter results for searches for parties within the application such as by, but not limited to, type of party and date of the party.

In embodiments, events may be created by the electronic device based computer application. These events may be entitled “Featured Events” and may take place at venues that work up a deal between the electronic device based computer application and the venue. The electronic device based computer application may provide paid promotion for these types of events.

In embodiments, the computer application may promote products, events, etc. through advertising on the computer application.

In embodiments, a user may need a college email in order to become an official user of the computer application.

In embodiments, a user of the application may be found via a search for the user's information such as, but not limited to, the user's first name, the user's last name, and the user's email address used to create a profile for the computer application.

In embodiments, the computer application may return search results of public events for a user based on the GPS location of the user.

In embodiments, the computer application may provide event information to a user based on the status of the user. For example, if a first user is friends with a second user that creates a private event, the computer application may allow the second user to send to the first user a message that may allow the first user to be invited and signed up for the private event.

In embodiments, the computing application may comprise a “night life” tab that, when engaged, may show user information pertaining to events that may occur at local bars and clubs (local based on the location of the user).

In embodiments, a user may, when creating an event profile, manually type in a description of the event. In embodiments, a user may, when creating an event profile, choose pre-established descriptive phrases that may describe the event. In embodiments, a user may, when creating an event profile, manually type in a description of the event and choose pre-established descriptive phrases that may describe the event.

In embodiments, within the computer application, a user may perform functions such as, but not limited to inviting friends to their party or someone else's party, creating parties, interacting within created parties, commenting on a party's page, adding profile images to a user's computer application profile, messaging other users, blocking other users, deleting users from a user's profile, and adding other users.

In embodiments, one or more of the first memory 120, second memory 220, third memory 320, fourth memory 420, and fifth memory 520 may act as and store information meant for one or more of the first memory 120, second memory 220, third memory 320, fourth memory 420, and fifth memory 520.

In embodiments, one or more of the first processor 110, second processor 210, third processor 310, fourth processor 410, and fifth processor 510 may act as and process information meant for one or more of the first memory 120, second memory 220, third memory 320, fourth memory 420, and fifth memory 520.

For the purposes of this disclosure, the terms “individual” and “user” may be synonymous.

For the purposes of this disclosure, the terms “planned real-world event” and “planned event” may be synonymous.

For the purposes of this disclosure, the phrase “at least one memory” may refer to at least one of memory 120, memory 220, memory 320, memory 420, and memory 520.

For the purposes of this disclosure, the phrase “at least one processor” may refer to at least one of processor 110, processor 210, processor 310, processor 410, and processor 510.

In embodiments, for a certain planned event, one or more users of an electronic device 205 that comprises an application that allows for the setup of a planned event may be authorized to add, edit and/or delete information pertaining to a planned event. In embodiments, the application may comprise computer readable code that may allow one or more users of the application to be authorized to add, edit, and/or delete information pertaining to a planned event.

The foregoing description of the preferred embodiments is provided to enable a person skilled in the art to make or use the claimed subject matter. Various modifications to these embodiments, including changing point values and/or adding or deleting point opportunities, will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and figures to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

1. A system comprising:
at least one processor;
at least one memory coupled with the at least one processor for storing planned event information relating to a plurality of planned real-world events, the planned event information comprising information identifying the plurality of planned real-world events;
an event registry module, operably coupled with a first processor and a first memory, the event registry module operable to provide the planned event information;
a second memory coupled with a second processor for storing personal identification information relating to a plurality of individual users;
a user registry module, operably coupled with the second processor and the second memory, the user registry module operable to provide the personal identification information for the plurality of individual users;
a third memory coupled with a third processor for storing event notification information;
an event notification module, operably coupled with the third processor and the third memory, the event notification module operable to receive at least a portion of the planned event information relating to the plurality of planned real-world events, the event notification module operable to receive at least a portion of the personal identification information for the plurality of individual users, the event notification module operable to determine, in relation to at least one authorization criteria, an authorizing relationship between the at least a portion of the planned event information for the plurality of planned real-world events and the at least a portion of the personal identification information for the plurality of individual users, the event notification module operable to provide the event notification information to each of the plurality of authorized users based on the authorizing relationship;
a fourth memory coupled with a fourth processor for storing event promotion information, the event promotion information comprising information for promoting attendance for at least one of the planned real-world events;
an event promotion module, operably coupled with the fourth processor and the fourth memory, the event promotion module operable to receive at least a portion of the planned event information, the event promotion module operable to receive event promotion information relating to at least a portion of the planned event information for at least one of the plurality of planned real-world events, the event promotion module operable to distribute to the authorized users the event promotion information relating to the at least one promoted real-world event;
a fifth memory coupled with a fifth processor for storing event monitoring information, the event monitoring information comprising information for monitoring at least one of the plurality of individual users;
an event monitoring module, operably coupled with the processor and the memory, the event monitoring module operable to receive at least a portion of the personal identification information for each of the plurality of individual users in attendance at an occurrence of at least one of the plurality of planned real-world events, the event promotion module operable to provide event monitoring information in relation to attendance at the occurrence of the at least one of the plurality of planned real-world events.

2. The system of claim 1, the event designated as a party.

3. The system of claim 1, the planned event information provided based on a GPS location of at least one of a plurality of individual users.

4. The system of claim 1, the planned event information provided based on a status of at least one of a plurality of individual users.

5. The system of claim 1, each of the plurality of planned real-world events classified as one of a public event, a partially public event, or a private event.

6. The system of claim 1, the event monitoring module operable to provide a timeframe of attendance for each of the plurality of individual users in attendance at an occurrence of at least one of the plurality of planned real-world events.

7. An apparatus comprising at least one non-transitory data storage device having one or more computer programs stored thereon and operable on one or more computing systems to:
store planned event information relating to a plurality of planned real-world events, the planned event information comprising information identifying the plurality of planned real-world events;
provide the planned event information;
store personal identification information relating to a plurality of individual users;
provide the personal identification information for the plurality of individual users;
store event notification information;
receive at least a portion of the planned event information relating to the plurality of planned real-world events;
receive at least a portion of the personal identification information for the plurality of individual users;
determine, in relation to at least one authorization criteria, an authorizing relationship between the at least a portion of the planned event information for the plurality of planned real-world events and the at least a portion of the personal identification information for the plurality of individual users;
provide the event notification information to each of the plurality of authorized users based on the authorizing relationship;
store event promotion information, the event promotion information comprising information for promoting attendance for at least one of the planned real-world events;
receive at least a portion of the planned event information;
receive event promotion information relating to at least a portion of the planned event information for at least one of the plurality of planned real-world events;
distribute to the authorized users the event promotion information relating to the at least one promoted real-world event;
store event monitoring information, the event monitoring information comprising information for monitoring at least one of the plurality of individual users;
receive at least a portion of the personal identification information for each of the plurality of individual users in attendance at an occurrence of at least one of the plurality of planned real-world events;
and
provide event monitoring information in relation to attendance at the occurrence of the at least one of the plurality of planned real-world events.

8. The apparatus of claim 7, the event designated as a party.

9. The apparatus of claim 7, the planned event information provided based on a GPS location of at least one of a plurality of individual users.

10. The apparatus of claim 7, the planned event information provided based on a status of at least one of a plurality of individual users.

11. The apparatus of claim 7, each of the plurality of planned real-world events classified as one of a public event, a partially public event, or a private event.

12. The apparatus of claim 7, the event monitoring module operable to provide a timeframe of attendance for each of the plurality of individual users in attendance at an occurrence of at least one of the plurality of planned real-world events.

13. A computer-implemented method comprising:
storing planned event information relating to a plurality of planned real-world events, the planned event information comprising information identifying the plurality of planned real-world events;
providing the planned event information;
storing personal identification information relating to a plurality of individual users;
providing the personal identification information for the plurality of individual users;
storing event notification information;
receiving at least a portion of the planned event information relating to the plurality of planned real-world events;
receiving at least a portion of the personal identification information for the plurality of individual users;
determining, in relation to at least one authorization criteria, an authorizing relationship between the at least a portion of the planned event information for the plurality of planned real-world events and the at least a portion of the personal identification information for the plurality of individual users;
providing the event notification information to each of the plurality of authorized users based on the authorizing relationship;
storing event promotion information, the event promotion information comprising information for promoting attendance for at least one of the planned real-world events;
receiving at least a portion of the planned event information;
receiving event promotion information relating to at least a portion of the planned event information for at least one of the plurality of planned real-world events;
distributing to the authorized users the event promotion information relating to the at least one promoted real-world event;
storing event monitoring information, the event monitoring information comprising information for monitoring at least one of the plurality of individual users;
receiving at least a portion of the personal identification information for each of the plurality of individual users in attendance at an occurrence of at least one of the plurality of planned real-world events;
and
providing event monitoring information in relation to attendance at the occurrence of the at least one of the plurality of planned real-world events.

14. The method of claim 13, the event designated as a party.

15. The method of claim 13, the planned event information provided based on a GPS location of at least one of a plurality of individual users.

16. The method of claim 13, the planned event information provided based on a status of at least one of a plurality of individual users.

17. The method of claim 13, each of the plurality of planned real-world events classified as one of a public event, a partially public event, or a private event.

18. The method of claim 13, the event monitoring module operable to provide a timeframe of attendance for each of the plurality of individual users in attendance at an occurrence of at least one of the plurality of planned real-world events.
